(19) United States
(12) Patent Application Publication
(10) Pub. No.: US 2010/0028623 A1
(43) Pub. Date: Feb. 4, 2010

(54) Laminated product and production method therof, and circuit substrate using the same

(75) Inventors: Toyonari Ito, Tsukuba-shi (JP); Satoshi Okamato, Tsukuba-shi (JP)

Correspondence Address: FOLEY AND LARDNER LLP;SUITE 500, 3000 K STREET NW, WASHINGTON, DC, 20007, US

(73) Assignee: SUMITOMO CHEMICAL COMPANY, LIMITED

(21) Appl. No.: 12/458,821

(22) Filed: Jul. 23, 2009

(30) Foreign Application Priority Data
Jul. 31, 2008 (JP) 2008-198426

(51) Int. Cl. B32B 15/08; B32B 7/02; B32B 3/10; B32B 37/12

(52) U.S. Cl. 428/195.1; 428/212; 428/215; 156/327

(57) ABSTRACT

The present invention provides a method for producing a laminated product, the method comprising the steps of: applying a solution containing a liquid-crystalline polymer and a solvent to a first metal layer, removing the solvent from the solution to form a liquid- crystalline polymer layer on the first metal layer, placing a second metal layer such that the liquid-crystalline polymer layer is placed between the first and second metal layers, and subjecting the liquid-crystalline polymer layer to compression from the direction of the first and second metal layers, wherein the thickness of the second metal layer is larger than that of the first metal layer. In the production method, the first metal layer preferably comprises a different metal from the second metal layer.

### BACKGROUND OF THE INVENTION

1. Field of the Invention

The invention relates to a laminated product, a production method, and a circuit substrate using the laminated product.

2. Description of the Related Art

In recent years, liquid-crystalline polymers with low water absorption property and excellent in electric properties have been investigated as insulating polymeric materials in substrates for printed circuit boards. For examples a laminated substrate obtained by laminating a film made of such a liquid-crystalline polymer on a metal foil capable of constituting a circuit (a conductive pattern) has been known. The laminated substrate can provide a multilayer printed circuit board by being multi-layered, which is advantageous in high-density wiring and a wide range of application. The laminated substrate can be produced by known methods (see, Japanese Patent Application Laid-Open (JP-A) No. 2008-73985).

### SUMMARY OF THE INVENTION

With respect to the laminated substrate described above, it has been investigated to use a laminated substrate in which a metal layer arranged in the reverse side to the metal layer capable of constituting a circuit is made to be a layer, for example, for heat radiation or the like as a circuit substrate or the like for a flat panel display. In this case, the metal layer capable of constituting a circuit among the metal layers formed on both faces tends to be processed to have a fine form at the time of forming a circuit (conductive) pattern. Therefore, the metal layer capable of constituting a circuit is desired to have strong adhesiveness to a liquid-crystalline polymer layer so as not to be peeled from the liquid-crystalline polymer layer even if a fine conductive pattern is formed. However, in general, in a case where another metal layer is further thermally press-bonded to the reverse side for a laminated product having a liquid-crystalline polymer layer and a metal foil in one side of the liquid-crystalline polymer layer, the adhesiveness of the metal layer laminated in advance and the liquid-crystalline polymer layer tends to be worsened. While the laminated product disclosed in JP-A No. 2008-73985 has high adhesiveness of the liquid-crystalline polyester film with the copper foils, it is required to be further improved in the adhesiveness of the copper foil particularly at the side in which the circuit pattern is to be formed when the laminated product is used for a circuit substrate for a flat panel display.

The present invention is made under the above-mentioned circumstances. Thus, one of objectives of the present invention is to provide a laminated product in which a liquid-crystalline polymer layer has a metal layer for forming a circuit at one side and also has another metal layer for a different purpose from the circuit formation on the opposite side, the laminated product having excellent adhesiveness especially between the liquid-crystalline polymer layer and the metal layer for providing the circuit.

The present inventors have keenly made investigations to achieve the objective. As a result, the present inventors have found that such a laminated product with excellent adhesiveness between the liquid-crystalline polymer layer and the metal layer for forming a circuit can be obtained by carrying out laminating the layers in a certain method, which results in accomplishing the present invention.

That is, the present invention provides a method for producing a laminated product, the method comprising the steps of:

applying a solution containing a liquid-crystalline polymer and a solvent to a first metal layer,

removing the solvent from the solution to form a liquid-crystalline polymer layer on the first metal layer,

placing a second metal layer such that the liquid-crystalline polymer layer is placed between the first and second metal layers, and

subjecting the liquid-crystalline polymer layer to compression from the direction of the first and second metal layers,

wherein the thickness of the first metal layer is larger than that of the second metal layer.

According to the production method of a laminated product of the present invention, for example, in the case where the first metal layer, the liquid-crystalline polymer layer and a second metal layer are disposed in this order, the first metal layer is especially firmly stuck to the liquid-crystalline polymer layer. There is a possibility that such effects of the present invention may be due to the further widened contact surface area of the liquid-crystalline polymer layer with the first metal layer, which may be attributed to the method in which (i) the liquid-crystalline polymer is applied on the first metal layer in a state of a solution (which results in that the liquid-crystalline polymer can penetrate even very small convexes and concaves of the first metal layer) and/or (ii) the compressing is conducted after the second metal layer is arranged.

The effects of the present invention are attained especially when the second metal layer has a thickness larger than that of the first metal layer. Thus, the present invention is advantageous especially when the first metal layer is a thinner conductive layer for circuit formation, the second metal layer is a layer with a larger thickness for heat radiation and a pattern for circuit is formed in the first metal layer. In the laminated product comprising such first and second layers and the liquid-crystalline polymer layer placed between the two metal layers, it is difficult for the first metal layer with the circuit pattern to peel off from the liquid-crystalline polymer layer, even when a fine pattern is formed onto the first metal layer.

In the present invention, it is preferred that the first metal layer and the second metal layer contain different metals. For example, the first metal layer preferably comprises a different metal from the second metal layer. In this case, even if a circuit pattern is formed on the first metal layer by a method such as etching treatment, an adverse effect of etching is scarcely caused on the second metal layer, and therefore, the second metal layer can sufficiently exhibit a function for heat radiation.

### BRIEF DESCRIPTION OF THE DRAWINGS

FIGS. 1(a) to 1(d) are process diagrams schematically showing one embodiment of a method for producing a circuit substrate in the present invention.

### DETAILED DESCRIPTION OF THE PREFERRED EMBODIMENTS

In the present invention, a laminated product comprising at least two metal layers and a layer comprising a liquid-crystalline polymer is provided. The laminated product can be produced by a method comprising the steps of:

applying a solution containing a liquid-crystalline polymer and a solvent to a first metal layer,

removing the solvent from the solution to form a liquid-crystalline polymer layer on the first metal layer,

placing a second metal layer such that the liquid-crystalline polymer layer is placed between the first and second metal layers, and

subjecting the liquid-crystalline polymer layer to compression from the direction of the first and second metal layers,

wherein the thickness of the first metal layer is larger than that of the second metal layer.

In the present invention, it is preferred to use a liquid-crystalline polymer having structural units represented by the following formulas (1), (2) and (3) shown below:

—O—Ar¹—CO— (1)

—CO—Ar²—CO— (2)

—X—Ar³—Y— (3)

wherein Ar¹ denotes a phenylene group or a naphthylene group; Ar² denotes a phenylene group, a naphthylene group, or a group represented by the formula (4) shown below;

—Ar⁴¹-Z-Ar⁴²— (4)

Ar³ denotes a phenylene group or a group represented by the formula (4); X and Y each independently denote an oxy group or an imino group; one or more hydrogen atoms of the phenylene group or the naphthylene group of Ar¹, Ar² and Ar³ may be substituted with a halogen atom, an alkyl group, or an aryl group; wherein Ar⁴¹ and Ar⁴² each independently denote a phenylene group or a naphthylene group; Z denotes an oxy group, a carbonyl group or a sulfonyl group; one or more hydrogen atoms of the phenylene group or the naphthylene group of Ar⁴¹ and Ar⁴² may be substituted with a halogen atom, an alkyl or an aryl. The liquid-crystalline polymer to be used preferably has 30 to 60% by mole of the structural unit represented by the formula (1), 20 to 35% by mole of the structural unit represented by the formula (2) and 20 to 35% by mole of the structural unit represented by the formula (3), based on the total amount of the structural units represented by the formulas (1), (2) and (3).

Such a liquid-crystalline polymer is excellent in solubility in a solvent. Therefore, in the present invention, the liquid-crystalline polymer is easy to be applied in a state of a solution to a metal layer and is thus suitable in the production method of the present invention. Particularly, the liquid-crystalline polymer is soluble even in a solvent hardly causing corrosion or the like of metal layers. Using such a liquid-crystalline polymer, the laminated product can be produced while sufficiently maintaining the properties of the metal layers.

Also, the liquid-crystalline polymer to be used in the present invention preferably has 20 to 35% by mole of at least one of structural units selected from the group consisting of structural units derived from aromatic diamines and structural units derived from aromatic amines having a hydroxyl group, based on the entire amounts of the structural units. Particularly, when the liquid-crystalline polymer has such structural units as selected from structural units derived from aromatic diamines or structural units derived from aromatic amines having a hydroxyl group, then the effects of the present invention tend to be attained more strongly.

Further, the first metal layer preferably contains copper and is more preferably made of copper. Furthermore, the second metal layer preferably contains aluminum or aluminum alloy and is more preferably made of aluminum or aluminum alloy. Since having low electric resistance, copper is particularly preferred as a material for providing a metal layer for circuit formation. Also, aluminum or aluminum alloy is preferred as a material for providing a metal layer for heat radiation because of relative lightweight. For example, even when the metal layer for heat radiation has a large thickness, the resulting circuit substrate (having the metal layer) does not become excessively heavy if the layer is made of aluminum or aluminum alloy.

Preferably, the production method of the present invention further comprises the step of orienting the liquid-crystalline polymer layer before placing the second layer. In this orienting step, molecules of the liquid-crystalline polymer can be oriented in a preferable direction, so that mechanical properties (e.g. tensile strength or the like) of the liquid-crystalline polymer layer tend to be more improved.

After the step of placing the second metal layer or after the optional orientating step, the liquid-crystalline polymer layer is subjected to compression preferably from the direction of the first and second metal layers. The compression step is preferably conducted as a higher temperature than that at which the orienting step is conduced to improve adhesiveness of the first metal layer to the liquid-crystalline polymer layer.

By the above described production method, an improved laminated product can be obtained. The laminated product may comprise a first metal layer, a liquid-crystalline polymer layer and a second metal layer disposed in this order. Preferably, the first metal layer has a thickness in the range of from 12 to 200 μm, which the second metal layer has a thickness in a range of from 1 to 5 mm.

In the laminated product, the liquid-crystalline polymer layer preferably has a thickness in the range of from 20 to 200 μm. When the thickness of the liquid-crystalline polymer layer is within this range, the adhesiveness of the liquid-crystalline polymer layer to the first metal layer and the second metal layer may be more improved, and the electric insulating property of the liquid-crystalline polymer layer may also be enhanced, favorably.

In such a laminated product, the first metal layer is preferably made of Copper. Further, the second metal layer is preferably made of aluminum or an aluminum alloy. When the first and second layers are made of such metals, the first metal layer tends to effectively attain properties preferable for circuit formation, and the second metal layer tends to effectively attain properties preferable for heat radiation.

Furthermore, the present invention provides a circuit substrate obtainable by forming a conductive pattern on the first metal layer of the laminated product in the present invention. With regard to such a circuit substrate, the conductive pattern is hardly peeled off from the liquid-crystalline polymer layer, since the adhesiveness of the first metal layer to the liquid-crystalline polymer layer in the laminated product (before forming the conductive pattern) is improved even if the conductive pattern is a fine pattern.

As described above, in accordance with the present invention, the improved laminated product can be produced. For example, the present invention provides a laminated product in which a first metal layer suitable for forming a circuit is placed on one side of a liquid-crystalline polymer layer, another metal layer suitable for different function from the circuit formation in the side opposite to the side on which the first layer has been placed (that is, the second metal layer is placed between the first and second layers). The laminated product has excellent adhesiveness particularly between the metal layer for the circuit and the liquid-crystalline polymer layer, and also provides the second metal layer with the preferable properties in, for example, heat radiation. Further, the present invention can provide a circuit substrate using the laminated product.

Hereinafter, preferred embodiments of the present invention will be described.

First, a liquid-crystalline polymer preferable for the production method in the present invention will be described.

The liquid-crystalline polymer used in a preferred embodiment is a polymer capable of forming a melt phase having optical anisotropy. Examples of the liquid-crystalline polymer include a liquid-crystalline polyester and a liquid-crystalline polyester amide mainly having a structure in which a main chain contains aromatic groups which are linked with ester bonds (namely, bonds represented by —C(O)O— or —OC(O)—) and amido bonds (namely, bonds represented by —C(O)NH—or —NHC(O)—). The aromatic groups include monocyclic aromatic groups, condensed ring aromatic groups, as well as groups obtained by direct bonding monocyclic aromatic groups or condensed ring aromatic groups, and also groups obtained by bonding monocyclic aromatic groups or condensed ring aromatic groups through an oxygen atom, a sulfur atom, and a bonding group such as an alkylene group having 1 to 6 carbon atoms, a sulfonyl group and a carbonyl group.

The liquid-crystalline polymer preferably has the structural units represented by the formulas (1), (2) and (3) as described above. More preferably, the liquid-crystalline polymer has 30 to 60% by mole of the structural unit represented by the formula (1), 20 to 35% by mole of the structural unit represented by the formula (2), and 20 to 35% by mole of the structural unit represented by the formula (3), respectively based on the total amount of the structural units represented by the formulas (1), (2) and (3). The liquid-crystalline polymer having the structural units satisfying with such conditions exhibits excellent strength and is excellent in insulating property as well as solubility in a solvent, and therefore, is suitable for produce a laminated product and a circuit substrate (or a member for a circuit substrate using the laminated product) in the present invention.

Examples of the preferred structural units represented by the formulas (1), (2) and (3) include the units as follows:

The structural unit represented by the formula (1) is preferably a structural unit derived from aromatic hydroxycarboxylic acids. Specific examples of the aromatic hydroxycarboxylic acids include p-hydroxybenzoic acid, 2-hydroxy-6-naphthoic acid, 4-hydroxy-4′-biphenylcarboxylic acid, and the like.

The structural unit represented by the formula (2) is preferably a structural unit derived from aromatic dicarboxylic acids. Specific examples of the aromatic dicarboxylic acids include terephthalic acid, isophthalic acid, 2,6-naphthalenedicarboxylic acid, diphenyl ether-4,4′-dicarboxylic acid, and the like.

The structural unit represented by the formula (3) is preferably a structural unit derived from aromatic diols, aromatic amines containing a hydroxyl group or aromatic diamines. Specific examples of the aromatic diols include hydroquinone, resorcin, 4,4′-dihydroxybiphenyl, and the like; examples of the aromatic amines containing a hydroxyl group include 3-aminophenol, 4-aminophenol, and the like: and specific examples of the aromatic diamines include 1,4-phenylenediamine, 1,3-phenylenediamine, and the like.

Among them, the structural unit represented by the formula (3) is more preferably at least one of structural units selected from the group consisting of a structural unit derived from the aromatic diamines and a structural unit derived from the aromatic amines containing a hydroxyl group. The resulting liquid-crystalline polymer tends to have increased solubility in a solvent, which results in easily preparing a liquid-crystalline polymer layer on a metal layer, using the solution containing the liquid-crystalline polymer and the solvent.

In the preferable embodiment, the liquid-crystalline polymer such as a liquid-crystalline polyester or liquid-crystalline polyester amide may be used. Examples of the preferable liquid-crystalline polyester or liquid-crystalline polyester amide include polyesters or polyester amide (A), (B) and (C) as described below.

That is, preferred are:

(A) liquid-crystalline polyesters having a structural unit derived from p-hydroxybenzoic acid and/or a structural unit derived from 2-hydroxy-6-naphthoic acid (structural unit of the formula (1)); a structural unit derived from at least one kind compound selected from the group consisting of isophthalic acid, terephthalic acid, and diphenyl ether-4,4′-dicarboxylic acid (structural unit of the formula (2)); and a structural unit derived from 4,4′-dihydroxybiphenyl (structural unit of the formula (3)) in combination:

(B) liquid-crystalline polyester amides having a structural unit derived from p-hydroxybenzoic acid and/or a structural unit derived from 2-hydroxy-6-naphthoic acid (structural unit of the formula (1)); a structural unit derived from at least one kind compound selected from the group consisting of isophthalic acid, terephthalic acid, and diphenyl ether-4,4′-dicarboxylic acid (structural unit of the formula (2)); and a structural unit derived from 4-aminophenol (structural unit of the formula (3)) in combination; and

(C) liquid-crystalline polyesters having a structural unit derived from p-hydroxybenzoic acid and/or a structural unit derived from 2-hydroxy-6-naphthoic acid (structural unit of the formula (1)); a structural unit derived from at least one kind compound selected from the group consisting of isophthalic acid, terephthalic acid, and diphenyl ether-4,4′-dicarboxylic acid (structural unit of the formula (2)); and a structural unit derived from 4,4′-dioxydiphenyl ether (structural unit of the formula (3)) in combination.

These liquid-crystalline polyesters and liquid-crystalline polyester amides can be produced by polymerizing raw material compounds (monomers), from which the respective structural units are derived, according to conventionally known methods disclosed in such as JP-A Nos. 2002-220444 and 2002-146003.

Specifically, examples of the method include acylation reaction of hydroxyl groups of the aromatic hydroxycarboxylic acids, monomers constituting the structural unit of the formula (1), and hydroxyl groups and amino groups of the aromatic diols, the aromatic diamines, and the aromatic amines containing a hydroxyl group, monomers constituting the structural unit of the formula (3) with an excess amount of fatty acid anhydrides to produce acyl compounds (acylation reaction) and then, ester-interchange/amido-interchange (polycondensation) reaction of the obtained acyl compounds with the aromatic dicarboxylic acids, monomers constituting the structural unit of the formula (2) by melt polymerization.

In the ester-interchange/amido-interchange reaction following the acylation reaction in such as a production method, it is preferable to adjust the total of acyl groups of the acyl compounds to be 0.8 to 1.2 equivalent times as much as the total of carboxyl groups of the aromatic dicarboxylic acids. Further, the ester-interchange/amido-interchange reaction is carried out preferably by increasing the temperature at a rate of 0.1 to 50° C./min from room temperature to 400° C. and more preferably by increasing at a rate of 0.3 to 5° C./min to 350° C. In addition, at the time of reaction, in order to advantageously produce the liquid-crystalline polymer by shifting the equilibrium, it is preferable to remove fatty acids produced as byproducts and un-reacted fatty acid anhydrides from the reaction system by evaporation or the like.

Further, after the melt polymerization is carried out as described above, solid-phase polymerization may be carried out to further increase the molecular weight of the polymer. The solid-phase polymerization is a method of carrying out polymerization in a solid-phase state at 150 to 350° C. for about 1 to 30 hours in an inert atmosphere of nitrogen or the like after the polymer obtained by the melt polymerization is further pulverized to be a powdery or flaky polymer.

The acylation reaction and the ester-interchange/amido-interchange reaction may be carried out in the presence of a catalyst. Applicable as the catalyst are those which are conventionally known as catalysts for polymerization of polyesters. Among them, metal salt catalysts, organic compound catalysts such as N-methylimidazole, and the like are preferable and organic compound catalysts are more preferable. Among the organic compound catalysts are heterocyclic compounds having two or more nitrogen atoms such as N-methylimidazole particularly preferable. In the case of using these catalysts, a catalyst is generally loaded before acylation reaction and may also be contained as it is in ester-interchange/amido-interchange reaction without being removed after the acylation reaction.

Further, the flow starting temperature of the liquid-crystalline polymer is preferably 230 to 350° C. and more preferably 250 to 330° C. A liquid-crystalline polymer having a flow start temperature in such a range tends to have sufficient solubility at the time of producing a solution containing the liquid-crystalline polyester to be used in the present invention and also tends to make it easy to form a liquid-crystalline polymer layer more excellent in mechanical properties by the above orientation step. Herein, the flow starting temperature is a temperature at which the melt viscosity becomes 4,800 Pa·s (48,000 poise) when the liquid-crystalline polymer is extruded from a nozzle at a increasing rate of a temperature of 4° C./min under a load of 9.8 MPa (100 Kg/cm²) using a capillary type rheometer equipped with a dice with an inner diameter of 1 mm and a length of 10 mm and it is an index which shows the molecular weight of a liquid-crystalline polyester as well known in the art (see “Liquid-crystallineline Polymer Synthesis, Molding, and Application” edited by Naoyuki Koide, pages 95 to 105, published by CMC on Jun. 5, 1987).

Next, a production method of a laminated product and a circuit substrate of preferred embodiments using the liquid-crystalline polymer will be described.

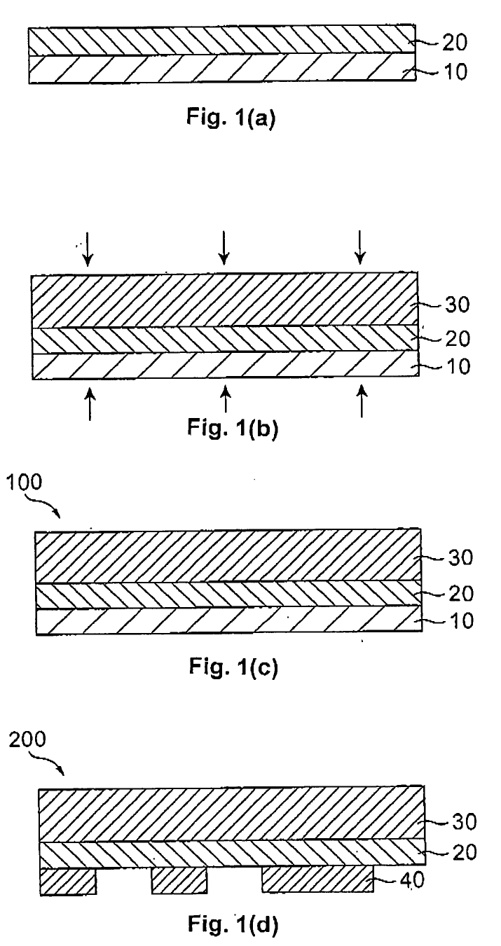

FIGS. 1(a) to 1(d) are process diagrams schematically showing one embodiment of the production method of a circuit substrate in the present invention.

In this embodiment, as shown in FIG. 1(a), onto a first metal layer 10, a liquid-crystalline polymer layer 20 is formed.

The first metal layer is a metal layer for providing a conductive pattern (circuit). The first metal layer may be a known metal foil, metal film or metal sheet, which is known for the similar purpose to forming pattern. Particularly, in order to obtain good adhesiveness of the liquid-crystalline polymer to the metal layer and to provide a circuit pattern with sufficiently low electric resistance, it is preferred to use a metal layer made of Cu, Ni, Ag or alloys thereof. Among them, a layer made of Cu is more preferred.

The thickness of first metal layer 10 is preferably in the range of from 12 to 200 μm, and more preferably in the range of from 18 to 100 μm. The first metal layer 10 having a thickness in this range can obtain the adhesiveness to the liquid-crystalline polymer layer 20. A conductive pattern is easily formed onto such a metal layer, the conductive pattern having good electric properties.

The liquid-crystalline polymer layer 20 is formed by applying a solution containing a liquid-crystalline polymer (a liquid-crystalline polymer solution) onto the first metal layer 10. Specifically, the liquid-crystalline polymer layer 20 may be formed by applying a solution containing a liquid-crystalline polymer and a solvent (capable of dissolving the polymer) to a first metal layer, and removing the solvent from the solution. Examples of the solvent capable of dissolving the liquid-crystalline polymer such as a liquid-crystalline polyester and/or polyester amide include phenolic solvents such as p-chlorophenol (PCP) and perfluorophenol; non-protonic polar solvents such as N-methyl-2-pyrrolidone (NMP), N,N-dimethylformamide (DMF), and N,N-dimethylacetamide (DMAc); and the like. These solvents can preferably dissolve the liquid-crystalline polymer and also tend to hardly cause corrosion of the first metal layer 10 or the like. The solvent may be a solvent obtained by mixing two or more solvents exemplified above and also a solvent obtained by mixing another solvent as long as the liquid-crystalline polymer maintain a high solubility in the resulting mixed solvent.

Depending on the properties desired, the liquid-crystalline polymer solution may contains organic filler, inorganic fill or the like as long as the properties of the liquid-crystalline polymer layer 20 needed to provide effects of the present invention are not adversely deteriorated so much. The fillers may be conventionally known fillers.

Examples of the applying method of the liquid-crystalline polymer to the first metal layer 10 include a bar coat method (e.g. a method of using a film applicator), a roller coat method, a gravure coat method, a knife coat method, a blade coat method, a rod coat method, a dip coat method, a spray coat method, a curtain coat method, a slot coat method and a screen printing method. Among these methods, a bar coat method and a knife coat method are preferred since the methods can form a liquid-crystalline polymer layer with a preferable, uniform thickness described later.

After applying the liquid-crystalline polymer solution to the first metal layer 10, the solvent in the solution may be removed from the solution by, for example, evaporating the solvent. The solvent can be evaporated by heating, pressure reduction and ventilation. Among them, due to high efficiency and favorable operation property, a method of heating is preferable, and a method of heating while blowing air is more preferable. The suitable solvent described above can be removed easily by these methods and are advantageous for formation of the liquid-crystalline polymer layer 2.

After the first step, the liquid-crystalline polymer contained in the liquid-crystalline polymer layer 20 formed on the first metal layer 10 is preferably oriented (orientation step). The orientation can be carried out by conventionally known orientation methods for a liquid-crystalline polymer and especially, preferably conducted by heating the liquid-crystalline polymer layer 20.

When the liquid-crystalline polyesters and liquid-crystalline polyester amides is to be oriented by heating, the heating is carried out preferably at 280 to 380° C. and more preferably at 250 to 360° C., while heating time is preferably 0.5 to 50 hours and more preferably 1 to 20 hours. Under such conditions, the liquid-crystalline polymer in the liquid-crystalline polymer layer is oriented well. When the removal of the solvent from the liquid-crystalline polymer solution is conducted by heating in the previous step for forming the polymer layer, the temperature can be properly set so as to simultaneously remove the solvent and to carry out orientation. In this case, the orientation and removal of the solvent is carried out simultaneously.

Next, in this embodiment, a second metal layer 30 having a thickness larger than that of the first metal layer is formed onto the side of the liquid-crystalline polymer layer 20 opposite to the side on which the first metal layer has been placed (see, FIG. 1(b)). Herein, the second metal layer 30 is preferably made of a material different from that of the first metal layer 10. As described above, the first metal layer is suitable for forming a circuit pattern when the laminated product is used as (a member for) a circuit substrate. The circuit pattern is formed by, for example, etching of the first metal layer 10. At that time, if the first metal layer and the second metal layer are made of approximately the same materials, the second metal layer 30 is etched more than a little and is possibly denatured when the first metal layer is etched. With the second metal layer denatured in such a manner, it may possibly results in an inconvenience that the intended function of heat radiation or the like is deteriorated in some cases. Accordingly, at the time of forming a circuit pattern in the first metal layer 10, in order not to cause a significant effect on the second metal layer 30, it is preferable to form the first metal layer 10 and the second metal layer 30 using mutually different materials.

When the second metal layer 30 in a circuit substrate as described below has a function of heat radiation or the like, the second metal layer 30 is preferably made of a material having high heat conductivity. However, since a metal layer with high heat conductivity tends to have a relatively high specific gravity, it becomes easy for the laminated product to have high weight. In this embodiment, since the second metal layer 30 has a large thickness than that of the first metal layer 10, the second metal layer 30 can sufficiently radiate heat even if the heat conductivity is lower than that of the first metal layer. Accordingly, even if the second metal layer 30 aims to radiate heat, the heat conductivity may be lower than that of the first metal layer 10. Herein, as the heat conductivity is employed a value measured by, for example, a laser flash method. The material of which the second metal layer 30 is made of is preferably selected, considering balance between the heat conductivity and specific gravity measured in the above-mentioned manner.

The material of which the second metal layer 30 is to be made of may be selected from the group consisting of Al and Al alloys (e.g. Al−Mg alloys, Al−Cu−Mg alloys, Al−Zn alloys, and Al−Mg−Si alloys), and is preferably those having lower specific gravity than the material of which the first metal layer 10 is made of. Among them, Al or an Al alloy containing Mg is more preferable as a material for the second metal layer 30.

The thickness of the second metal layer 30 is preferably in the range of from 1 to 5 mm and is more preferably in the range of from 1 to 3 mm. When the second metal layer 30 has such a thickness, the second metal layer 30 easily exhibits sufficient properties such as heat radiation in a laminated product.

Thus prepared laminate having the first metal layer 10, the liquid-crystalline polymer layer 20 and the second metal layer 30 disposed in this order is subjected to be compressed from the direction of the first and second metal layers (seer FIG. 1(b)), to provide a laminated product 100 in which the respective layers are firmly stuck to one another (FIG. 1(c)). Compression can be carried out by applying pressure in the lamination direction while heating the laminate which has been obtained before pressing. The heating temperature at this time is preferably higher than that at which the orientation step is conducted.

Based on the investigations of which the inventors have made, it is found that in the laminated product 100 obtained by pressing at a temperature higher than that in the orientation step, the adhesiveness between the first metal layer 10 and the liquid-crystalline polymer layer 20 is not deteriorated, but the adhesiveness between them is rather improved. The reasons for such an effect are not made clear; however as described above, it is supposed that since the liquid-crystalline polymer is applied in a solution state, the liquid-crystalline polymer penetrates even in the very small convexes and concaves of the first metal layer and therefore, the contact surface area of the liquid-crystalline polymer layer 20 and the first metal layer 10 can be more widened.

More specifically, the heating temperature at the time of pressing is set preferably 300 to 400° C. and more preferably 300 to 360° C. The pressurizing condition at the time of pressing is preferably 1 to 30 MPa and more preferably 3 to 30 MPa. It is made possible to obtain good adhesiveness particularly between the first metal layer 10 and the liquid-crystalline polymer layer 20 by satisfying these conditions.

According to the above method, the laminated product 100 in which the first metal layer 10, the liquid-crystalline polymer layer 20, and the second metal layer 30 are firmly stuck to one another can be obtained. In the laminated product 100, the thickness of the liquid-crystalline polymer layer 20 is preferably 20 to 200 μm and more preferably 50 to 150 μm. The liquid-crystalline polymer layer 20 having the thickness described above can have excellent strength and insulating property although being a thin insulating layer and thus suitable as an insulating base material in a circuit substrate or the like described below. Further, employment of the above orientation step makes the laminated product 100 remarkably excellent also in the mechanical properties such as tensile strength. Additionally, in order to form the liquid-crystalline polymer layer 20 with a desired thickness, in the first step, the concentration and the application amount of the liquid-crystalline polymer solution and/or the times of the application may be properly set.

A step of processing the first metal layer 10 into a form of a conductive pattern 40 is carried out for the laminated product 100 obtained in the above-mentioned manner to obtain a circuit substrate 200 (FIG. 1D). For a method of processing the first metal layer 10 into a form of the conductive pattern, for example, a known lithographic method or the like can be employed which involves forming a desired pattern of resistor the like on the first metal layer 10 and thereafter removing parts of the first metal layer 10 by etching or the like using the desired resist pattern as a mask.

The circuit substrate 200 obtained in the above manner has a three-layer structure including the liquid-crystalline polymer layer 20 as an insulating base material and the conductive pattern 40 on one face of the liquid-crystalline polymer layer and the second metal layer 30 having a function of heat radiation or the like on the face in the reverse side to the conductive pattern 40.

With respect to the circuit substrate 200, the conductive pattern 40 is formed using the first metal layer 10 which is coated with the liquid-crystalline polymer solution in the case of producing the laminated product 100, so that the adhesiveness to the liquid-crystalline polymer layer 20 can be high. Accordingly, even having very fine pattern form, the conductive pattern 40 is hardly peeled from the liquid-crystalline polymer layer 20.

The invention being thus described, it will be apparent that the same may be varied in many ways. Such variations are to be regarded as within the spirit and scope of the invention, and all such modifications as would be apparent to one skilled in the art are intended to be within the scope of the following claims.

### EXAMPLES

The present invention is described in more detail by following Examples, which should not be construed as a limitation upon the scope of the present invention.

### Example 1

A reactor equipped with a stirrer, a torque meter, a nitrogen gas introduction pipe, a thermometer, and a reflux condenser was loaded with 1976 g (10.5 mole) of 2-hydroxy-6-naphthoic acid, 1474 g (9.75 mole) of 4-acetaminophene, 1620 g (9.75 mole) of isophthalic acid, and 2374 g (23.25 mole) of acetic anhydride. After the inside of the reactor was sufficiently replaced with nitrogen gas, the temperature was increased to 150° C. for 15 minutes under nitrogen gas current and kept constant and the contents were stirred for 3 hours.

Next, while distilled acetic acid produced as byproduct and un-reacted acetic anhydride were removed, the solution in the reactor was heated to 320° C. for 170 minutes and the moment the torque increase was observed was regarded as the completion of reaction and the contents were taken out. The obtained solid matter was cooled to room temperature and pulverized by a coarsely pulverizing apparatus to obtain a powdery liquid-crystalline polymer. Thereafter, the obtained powder was subjected to solid phase polymerization in condition of keeping at 250° C. for 3 hours in nitrogen atmosphere and cooled to obtain a powder of a liquid-crystalline polymer. The flow starting temperature of the powder of the liquid-crystalline polymer was measured to find out that it was 270° C.

Next, 22 g of the obtained liquid-crystalline polymer powder was added to 78 g of DMAc and stirred at 100° C. for 2 hours to obtain a brown and transparent solution. Based on visual observation, the powder of the liquid-crystalline polymer was completely dissolved. The solution was stirred and defoamed to obtain a liquid-crystalline polymer solution. The solution viscosity of the liquid-crystalline polymer solution was 275 cp. The solution viscosity was a value measured at measurement temperature of 23° C. using a B type viscometer (manufactured by Toki Sangyo Co., Ltd.; TVL-20 model, rotor No. 21 (rotation speed: 5 rpm)).

Next, the obtained liquid-crystalline polymer solution was applied to an electrolytic copper foil, a first metal layer (manufacture by Fukuda Metal Foil & Powder Co., Ltd.; CF-T8G-HTE, thickness 70 μm) by a film applicator (coating thickness 250 μm) and the obtained foil was dried on a hot plate at 80° C. for 6 hours to remove DMAc from the solution and form a liquid-crystalline polymer layer. Successively, heating treatment of increasing the temperature to 320° C. from 30° C. at a temperature increasing speed of 3.2° C./min in a hot blast type oven under nitrogen atmosphere and keeping at 320° C. for 3 hours was carried out to orient the liquid-crystalline polymer.

Thereafter, an Al alloy (an Al−Mg alloy; Al alloy standard A5052, thickness 2 mm), a second metal layer, was formed on the liquid-crystalline polymer layer and the obtained laminated product before pressing was pressed in the lamination direction while being heated to obtain a laminated product in which the electrolytic copper foil, the liquid-crystalline polymer layer, and the Al alloy sheet are laminated in this order and firmly stuck to one another. The pressing was carried out in a heating treatment condition of heating to 320° C. for 60 minutes under vacuum and thereafter keeping at the same temperature for 20 minutes and in a condition of pressing pressure of 5 MPa.

### Example 2

A laminated product was obtained in the same manner as in Example 1, except that the pressing condition of the laminated product before pressing was changed to that the finally reaching temperature was 340° C.

### Comparative Example 1

A laminated product was obtained in the same manner as in Example 1, except that the Al alloy sheet (an Al−Mg alloy; Al alloy standard A5052, thickness 2 mm) was used as the first metal layer and the electrolytic copper foil (manufacture by Fukuda Metal Foil & Powder Co., Ltd.; CF-T8G-HTE, thickness 70 μm) was used as the second metal layer. That is, the laminated product of Comparative Example 1 was obtained by firstly forming the liquid-crystalline polymer layer on the Al alloy sheet and thereafter arranging the electrolytic copper foil and carrying out the pressing.

### Comparative Example 2

A laminated product was obtained in the same manner as in Comparative Example 1, except that the pressing condition of the laminated product before pressing was changed to that the finally reaching temperature was 340° C.

### Evaluation of Properties

Peeling test pieces with 10 mm width were obtained by cutting off the respective laminated bodies of Examples 1 and 2 and Comparative Examples 1 and 2. With respect to these peeling test pieces, 90° peeling strength at the time of peeling the electrolytic copper foil (Autograph AG-5000D, manufactured by Shimadzu Corporation; peeling speed 50 mm/min) was measured to determine the adhesive strength of the electrolytic copper foil in the respective laminated bodies to the liquid-crystalline polymer layer in the MD direction and TD direction. The obtained results are collectively shown in Table 1.

The MD direction means the moving direction of the applicator at the time of applying the liquid-crystalline polymer solutions using a film applicator and the TD direction means the direction rectangular to the MD direction, in the plane direction of the obtained liquid-crystalline polymer layer.

TABLE 1

| Laminated | | | | Comparative | Comparative |
|---|---|---|---|---|---|
| product | | Example 1 | Example 2 | Example 1 | Example 2 |
| 90° | MD | 4.4 | 34.5 | 2.2 | 14.2 |
| peeling | TD | 6.5 | 31.4 | 2.0 | 14.2 |
| strength | | | | | |
| (N/cm) | | | | | |

As shown in Table 1, in comparison of those pressed in the same pressing condition, it was confirmed that the laminated bodies of Examples 1 and 2 obtained by applying the liquid-crystalline polymer solution to the electrolytic copper foil and thereafter laminating the Al alloy sheet and carrying out pressing had improved adhesiveness between the electrolytic copper foil and the liquid-crystalline polymer layer as compared with the laminated bodies of Comparative Examples 1 and 2 obtained by laminating the electrolytic copper foil after applying the liquid-crystalline polymer solution to the Al alloy sheet and pressing the resulting laminated bodies. In Examples 1 and 2 and Comparative Examples 1 and 2, peeling was caused between the electrolytic copper foil and the liquid-crystalline polymer layer in the test pieces after the peeling strength measurement.

It was found out that the laminated product of Example 2 obtained by allowing the heating temperature at the time of pressing to be higher than that in the heat treatment for orientation had remarkably high adhesiveness between the electrolytic copper foil and the liquid-crystalline polymer layer compared with the laminated product of Example 1 obtained by keeping these heating temperatures same.

1. A method for producing a laminated product, the method comprising the steps of:
applying a solution containing a liquid-crystalline polymer and a solvent to a first metal layer,
removing the solvent from the solution to form a liquid-crystalline polymer layer on the first metal layer,
placing a second metal layer such that the liquid-crystalline polymer layer is placed between the first and second metal layers, and
subjecting the liquid-crystalline polymer layer to compression from the direction of the first and second metal layers,
wherein the thickness of the second metal layer is larger than that of the first metal layer.

2. The method according to claim 1, wherein the first metal layer comprises a different metal from the second metal layer.

3. The method according to claim 1, wherein the liquid-crystalline polymer has structural units represented by the formulas (1), (2) and (3) shown below:
—O—Ar¹—CO— (1)
—CO—Ar²—CO— (2)
—X—Ar³—Y— (3)
wherein Ar¹ denotes a phenylene group or a naphthylene group; Ar² denotes a phenylene group, a naphthylene group, or a group represented by the formula (4) shown below;
—Ar⁴¹-Z-Ar⁴²— (4)
Ar³ denotes a phenylene group or a group represented by the formula (4); X and Y each independently denote an oxy group or an imino group; one or more hydrogen atoms of the phenylene group or the naphthylene group of Ar¹, Ar² and Ar³ may be substituted with a halogen atom, an alkyl group, or an aryl group;
wherein Ar⁴¹ and Ar⁴² each independently denote a phenylene group or a naphthylene group; Z denotes an oxy group, a carbonyl group or a sulfonyl group; one or more hydrogen atoms of the phenylene group or the naphthylene group of Ar⁴¹ and Ar⁴² may be substituted with a halogen atom, an alkyl or an aryl; and
wherein the polymer has 30 to 60% by mole of the structural unit represented by the formula (1), 20 to 35% by mole of the structural unit represented by the formula (2) and 20 to 35% by mole of the structural unit represented by the formula (3), based on the total amount of the structural units represented by the formulas (1), (2) and (3).

4. The method according to claim 1, wherein the liquid-crystalline polymer has 20 to 35% by mole, based on the entire structural units, of at least one of structural units selected from the group consisting of structural units derived from aromatic diamines and structural units derived from aromatic amines having a hydroxyl group.

5. The method according to claim 1, wherein the first metal layer contains copper.

6. The method according to claim 1, wherein the second metal layer contains aluminum or aluminum alloy.

7. The method according to claim 1, further comprising the step of orienting the liquid-crystalline polymer layer before placing the second layer.

8. The method according to claim 7, wherein the compression step is conducted at a higher temperature than that at which the orienting step is conducted.

9. A laminated product obtainable by the method according to claim 1.

10. The laminated product according to claim 9, the product comprising a first metal layer, a liquid-crystalline polymer layer and a second metal layer disposed in this order, wherein the first metal layer has a thickness of from 12 to 200 μm, and the second metal layer has a thickness of from 1 to 5 mm.

11. The laminated product according to claim 10, wherein the liquid-crystalline polymer layer has a thickness of from 20 to 200 μm.

12. The laminated product according to claim 10, wherein the first metal layer contains copper.

13. The laminated product according to claim 10, wherein the second metal layer contains aluminum or aluminum alloy.

14. A circuit substrate obtainable by forming a conductive pattern on the first metal layer of the laminated product according to claim 9.
